(19) United States
(12) Patent Application Publication
(10) Pub. No.: US 2015/0352529 A1
(43) Pub. Date: Dec. 10, 2015

(54) Influence of Type of Support Oxide on Stability of Copper-Manganese Zero-PGM Catalyst

(71) Applicants: Zahra Nazarpoor, Camarillo, CA (US); Stephen Golden, Santa Barbara, CA (US)

(72) Inventors: Zahra Nazarpoor, Camarillo, CA (US); Stephen Golden, Santa Barbara, CA (US)

(21) Appl. No.: 14/297,358

(22) Filed: Jun. 5, 2014

(51) Int. Cl. B01J 23/889; B01J 37/08; B01J 23/00

(52) U.S. Cl. CPC B01J 23/8892; B01J 23/005; B01J 37/08

(57) ABSTRACT

Variations of metal oxide materials used as support oxide for Cu—Mn spinel powder for ZPGM TWC applications are disclosed. Bulk powder catalyst samples of Cu—Mn spinel structure on MgAl₂O₄, Al₂O₃-9% BaO, Al₂O₃—SrO, Al₂O₃—CeO, CeO₂—ZrO₂ support oxides and among others are prepared using incipient wetness method. BET-surface area analysis is performed for selected support oxides before and after deposition of Cu—Mn spinel to analyze thermal stability. XRD analysis is performed for bulk powder catalyst samples to investigate Cu—Mn spinel phase formation, and phase stability for a plurality of temperatures to about 1000° C. Activity measurements under isothermal steady state sweep test condition may be performed under rich condition to lean condition for different aging temperature at about 800° C. and about 1000° C. Catalytic activity of samples may be compared to analyze the influence that selected support oxides may have on thermal stability and TWC performance of ZPGM materials for a plurality of TWC applications.

### BACKGROUND

1. Field of the Disclosure

This disclosure relates generally to catalyst materials, and more particularly, to the influence of a plurality of support oxides on stability of catalyst materials including Cu—Mn spinel phase, and performance of Zero-PGM (ZPGM) for three-way catalyst (TWC) applications.

2. Background Information

Preparation of supported catalysts involves several important steps, such as choice of appropriate catalyst support oxide, choice of method of deposition of the active phase on support oxide, among others. As catalyst performance depends on the methods of preparation, properties of the catalyst materials, and number of metal sites, in regards to their characteristics and location on the support, can be controlled by right selection of noble metals and transition metal oxide compounds. Addition of active metal oxides can modify the catalyst texture and porosity, increase dispersion and reducibility, as well as the fraction of different metal crystalline phases. Additionally, oxide compounds may enhance mechanical resistance and improve chemical stability of the support oxide.

As catalyst attributes of activity, stability, selectivity, and regenerability can be related to the physical and chemical properties of the catalyst materials and support oxide materials, which in turn can be related to the parameters in the method of preparation of the catalyst, the slurry characteristics of materials used are influential to the thermal stability.

Three-way catalyst (TWC) systems may include a support of alumina upon which promoting oxides and bimetallic catalysts, based on Platinum group metals (PGMs), are deposited. Although these PGM catalysts may be effective for toxic emission control and have been commercialized in industry, PGM materials are scarce and expensive. This high cost remains a critical factor for wide spread applications of these catalysts. One possible alternative may be the utilization of Zero-PGM catalysts that are abundant and less expensive than PGMs, but require high surface area support oxide material to be thermally stable.

Catalytic materials used in TWC systems have changed, and the new materials have to be thermally stable under the fluctuating exhaust gas conditions. The attainment of the requirements regarding the techniques to monitor the degree of the catalyst's deterioration/deactivation demands highly active and thermally stable catalysts.

According to the foregoing reasons, there may be a need to provide support oxide materials for ZPGM catalyst systems for cost effective manufacturing, such that catalytic performance may be improved, using a plurality of support oxide materials for suitable ZPGM catalyst, that can be used in a variety of environments and TWC applications.

### SUMMARY

The present disclosure may provide material compositions of Cu—Mn spinel structure on a plurality of support oxides to determine the influence of support oxides on stability and TWC performance, which may be made available for utilization as bulk powder catalyst materials for the manufacturing of ZPGM catalysts for TWC applications.

According to embodiments in present disclosure, catalyst samples may be prepared using incipient wetness (IW) of Cu—Mn spinel solution on a plurality of support oxides to form bulk powder, as known in the art. Cu—Mn spinel structure may be prepared at different molar ratios according to general formulation CuₓMn₃₋ₓO₄, where X may be variable of different molar ratios within a range from about 0.02 to about 1.5. In present disclosure, Cu₁Mn₂O₄ spinel solution may be supported on MgAl₂O₄, Al₂O₃-9% BaO, Al₂O₃-15% SrO, Al₂O₃-5% SrO, CeO₂—ZrO₂, Alumino silicate, Al₂O₃-8% CeO₂, Al₂O₃-10% La₂O₃, SiO₂, among others, which may be subsequently dried, calcined, and ground to bulk powder.

According to one aspect of the present disclosure, to determine thermal stability of bulk powder catalyst samples of Cu—Mn spinel on the selected support oxides, BET-surface area analysis may be performed at a plurality of temperatures.

According to another aspect of the present disclosure, to determine Cu—Mn spinel phase formation and stability, bulk powder catalyst samples may be prepared for XRD analysis. XRD analysis may provide the temperature at which Cu—Mn spinel phase may be formed, as well as the temperature at which the Cu—Mn spinel may be stable. The temperature of spinel formation may be used as the temperature of firing during catalyst manufacturing, and the temperature of stability may point to a selected application.

TWC performance of bulk powder catalyst samples, per selected support oxide in present disclosure, may be determined by performing isothermal steady state sweep test. The isothermal steady state sweep test may be performed at a selected inlet temperature using an 11-point R-value from rich condition to lean condition at a plurality of space velocities (SV). In present disclosure, SV may be adjusted to about 40,000 h⁻¹. Results from isothermal steady state sweep test may be compared to show the influence that different support oxides may have on TWC performance of catalyst samples.

According to principles in present disclosure, support oxides may have an influence on stability and performance of powder catalyst samples including Cu—Mn spinel phase. The TWC property of bulk powder catalyst samples may provide an indication that for catalyst applications, catalyst systems including Cu—Mn spinel may be more efficient operationally-wise, and from a catalyst manufacturer's viewpoint, an essential advantage given the economic factors involved.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 shows BET-surface area analysis of a plurality of selected support oxides and powder catalyst samples of Cu—Mn spinel on same support oxides, at temperature of about 1000° C., according to an embodiment.

FIG. 2 illustrates XRD analysis for Cu—Mn spinel phase formation and phase stability of bulk powder Cu—Mn spinel supported on Alumina-Strontium oxide, at different firing temperatures, according to an embodiment.

FIG. 3 depicts NOₓ conversion comparison for bulk powder catalyst samples of Cu—Mn spinel structure on a plurality of selected support oxides, according to an embodiment.

FIG. 4 shows catalyst performance for bulk powder catalyst samples of Cu—Mn spinel structure on Alumina-5% Strontium support oxides, under isothermal steady state sweep condition, at inlet temperature of about 450° C. and SV of about 40,000 h⁻¹, according to an embodiment. FIG. 4A illustrates catalyst performance for bulk powder catalyst samples of Cu—Mn spinel structure on Al₂O₃-5% SrO support oxide after aging at about 800° C.; FIG. 4B depicts catalyst performance for bulk powder catalyst samples of Cu—Mn spinel structure on Al₂O₃-5% SrO support oxide after aging at about 1000° C.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Platinum Group Metal (PGM)” refers to platinum, palladium, ruthenium, iridium, osmium, and rhodium.

“Zero platinum group (ZPGM) catalyst” refers to a catalyst completely or substantially free of platinum group metals.

“Catalyst” refers to one or more materials that may be of use in the conversion of one or more other materials.

“Adsorption” refers to the adhesion of atoms, ions, or molecules from a gas, liquid, or dissolved solid to a surface.

“Incipient wetness (IW)” refers to the process of adding solution of catalytic material to a dry support oxide powder until all pore volume of support oxide is filled out with solution and mixture goes slightly near saturation point.

“Calcination” refers to a thermal treatment process applied to solid materials, in presence of air, to bring about a thermal decomposition, phase transition, or removal of a volatile fraction at temperatures below the melting point of the solid materials.

“Treating, treated, or treatment” refers to drying, firing, heating, evaporating, calcining, or mixtures thereof.

“Spinel” refers to any of various mineral oxides of magnesium, iron, zinc, or manganese in combination with aluminum, chromium, copper or iron with AB₂O₄ structure.

“Conversion” refers to the chemical alteration of at least one material into one or more other materials.

“R-value” refers to the number obtained by dividing the reducing potential by the oxidizing potential of materials in a catalyst.

“Rich condition” refers to exhaust gas condition with an R-value above 1.

“Lean condition” refers to exhaust gas condition with an R-value below 1.

“Air/Fuel ratio” or “A/F ratio” refers to the weight of air divided by the weight of fuel.

“Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“X-ray diffraction (XRD) analysis” refers to a rapid analytical technique that investigates crystalline material structure, including atomic arrangement, crystalline size, and imperfections in order to identify unknown crystalline materials (e.g. minerals, inorganic compounds).

“Brunauer-Emmett-Teller (BET) surface area analysis” refers to an analytical technique that determines specific surface area of a powder by physical adsorption of a gas on the surface of the solid, and by calculating the amount of adsorbate gas corresponding to a mono-molecular layer on the surface.

### DESCRIPTION OF THE DRAWINGS

The present disclosure may provide bulk powder material compositions including Cu—Mn spinel structure on a plurality of support oxides, and their influence on TWC performance, to develop suitable Zero-PGM (ZPGM) catalyst materials, which may ensure the identification of support oxide materials, capable of providing high chemical reactivity, and thermal and mechanically stability. Aspects that may be treated in present disclosure may show improvements in the process for overall catalytic conversion capacity for a plurality of ZPGM catalysts, which may be suitable for TWC applications.

Bulk Powder ZPGM Catalyst Material Composition and Preparation

In the present disclosure, ZPGM material compositions in form of bulk powder may be prepared including Cu—Mn spinel at different molar ratios according to general formulation CuₓMn₃₋ₓO₄, where X may be variable of different molar ratios within a range from about 0.02 to about 1.5. Cu—Mn spinel may be supported on a plurality of support oxides, such as MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumino silicate, ZrO₂—Y₂O₃—SiO₂, Al₂O₃—CeO₂, Al₂O₃—SrO, TiO₂-10% ZrO₂, TiO₂-10% Nb₂O₅, SnO₂—TiO₂, ZrO₂—SnO₂—TiO₂, BaZrO₃, BaTiO₃, BaCeO₃, ZrO₂—P₆O₁₁, ZrO₂—Y₂O₃, ZrO₂—Nb₂O₅, among others.

Preparation of bulk powder catalyst samples may begin by preparing the solution for Cu—Mn spinel by mixing the appropriate amount of Cu nitrate solution and Mn nitrate solution with water to make solution at different molar ratios. Accordingly, solution of Cu—Mn may be subsequently added drop-wise to a plurality of support oxide powders via incipient wetness (IW) method, as known in the art. Then, mixture may be dried at about 120° C. overnight and calcined at a plurality of temperatures within a range from about 600° C. to about 1000° C. In present disclosure, calcination may be preferably performed at about 800° C. for about 5 hours. Subsequently, calcined material of Cu—Mn binary spinel on a plurality of support oxides may be ground to make fine grain bulk powder.

In present disclosure, support oxides selected to determine the influence on the Cu—Mn spinel stability may be MgAl₂O₄, Al₂O₃-9% BaO, Al₂O₃-15% SrO, Al₂O₃-5% SrO, CeO₂—ZrO₂, Alumino silicate, Al₂O₃-8% CeO₂, Al₂O₃-10% La₂O₃, and SiO₂.

BET-Surface Area Analysis

The thermal stability of selected support oxides before and after deposition of Cu—Mn spinel may be measured by performing Brunauer-Emmett-Teller (BET) surface area analysis, as known in the art.

Prior to any measurement, bulk powder samples must be degassed to remove water and other contaminants before the surface area can be accurately measured. Bulk powder samples may be degassed in a vacuum at a plurality of high temperatures. The highest temperature possible that may not damage the powder sample's structure may be usually chosen to shorten the degassing time. A minimum of about 0.5 g of sample may be required for the BET to successfully determine the surface area. Powder samples may be placed in glass cells to be degassed and analyzed by the BET-surface area measurement analyzer. In present disclosure, BET-surface area analysis may be preferably performed at about 1000° C. for selected support oxides and also bulk powder catalyst of Cu—Mn spinel on same support oxides.

X-ray Diffraction Analysis for Cu—Mn Spinel Phase Formation and Stability

Spinel phase formation and stability of the Cu—Mn spinel phase may be subsequently analyzed/measured using X-ray diffraction (XRD) analysis. The plurality of variations in present disclosure that may result from successive XRD analysis may produce corresponding phase diagrams. XRD data may then be analyzed and a new phase may be determined and selected in conformity with a different calcination temperature. This calibration may lead to improved variations to produce optimal performance and durability of catalysts including Cu—Mn spinel on selected support oxides. The XRD analysis may be conducted to determine the phase structure Cu—Mn material on selected support oxides that according to principles in the present disclosure may be calcined at temperatures within the range of about 600° C. to about 1000° C. for about 5 hours.

The XRD patterns may be measured on a Rigaku® powder diffractometer (MiniFlex™) using Cu Ka radiation in the 2-theta range of about 15°-100° with a step size of about 0.02° and a dwell time of about 1 second. The tube voltage and current may be set at about 40 kV and about 30 mA, respectively. The resulting diffraction patterns may be analyzed using the International Center for Diffraction Data (ICDD) database.

XRD analysis may also provide an indication that for catalyst applications the chemical composition of the Cu—Mn spinel on selected support oxide may show enhanced stability at a plurality of temperatures of operation in TWC applications.

Isothermal Steady State Sweep Test Procedure

The isothermal steady state sweep test may be done employing a flow reactor at inlet temperature of about 450° C., and testing a gas stream at 11-point R-values from about 2.0 (rich condition) to about 0.8 (lean condition) to measure the CO, NO, and HC conversions. In present disclosure, gas stream may be tested at R-values from about 1.6 (rich condition) to about 0.9 (lean condition) to measure the CO, NO, and HC conversions.

The space velocity (SV) in the isothermal steady state sweep test may be adjusted at about 40,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of NOₓ, about 2,000 ppm of H₂, about 10% of CO₂, and about 10% of H₂O. The quantity of O₂ in the gas mix may be varied to adjust Air/Fuel (A/F) ratio within the range of R-values to test the gas stream.

The NO/CO cross over R-value, where NO and CO conversions are equal, of bulk powder catalyst samples, per selected support oxide, may be determined and compared by performing isothermal steady state sweep test. Results from isothermal steady state test may be compared to show the influence of selected support oxides on TWC performance.

Thermal Stability of Support Oxides

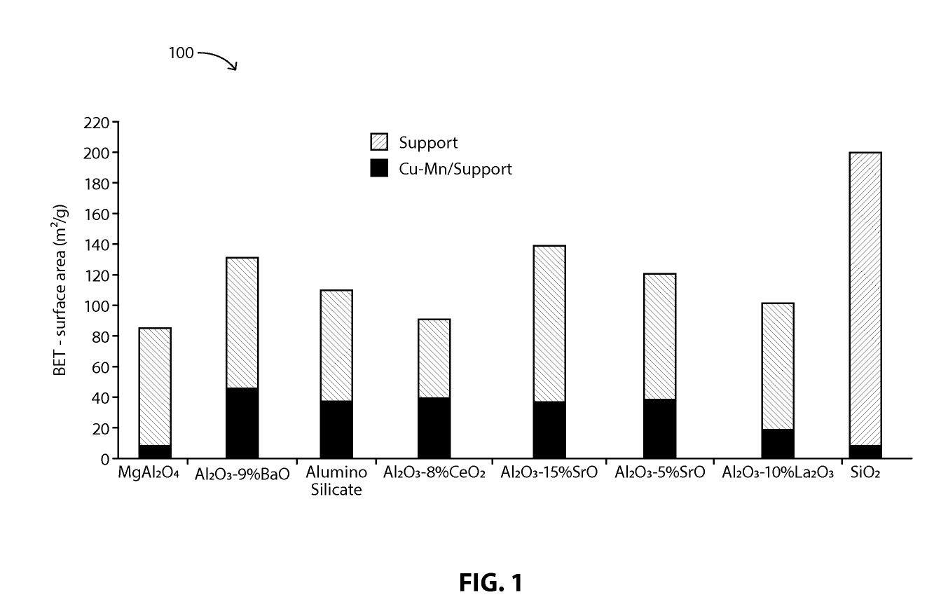

FIG. 1 shows BET-surface area analysis 100 of a plurality of selected support oxides and powder catalyst samples of Cu—Mn spinel structure on these support oxides, after aging at temperature of about 1000° C., according to an embodiment.

As may be observed in FIG. 1, all selected support oxides, such as MgAl₂O₄, Al₂O₃-9% BaO, Alumino silicate, Al₂O₃-8% CeO₂, Al₂O₃-15% SrO, Al₂O₃-5% SrO, Al₂O₃-10% La₂O₃, and SiO₂, show high surface area in the range of about 80 to about 200 m²/g after aging at about 1000° C. in air for duration of 4 hours prior to IW of Cu—Mn spinel. However, among them, SiO₂, Al₂O₃-15% SrO, and Al₂O₃-9% BaO support oxides show the highest surface areas before deposition of Cu—Mn. BET-surface areas of SiO₂, Al₂O₃-15% SrO, and Al₂O₃-9% BaO support oxides are about 198.5 m²/g, about 138.1 m²/g, and about 131 m²/g, respectively.

BET-surface area analysis, after IW of Cu—Mn spinel powder on support oxides and aging at about 1000° C., shows that surface area decreases in comparison with surface area of bare support oxides at the same aging temperature, as may be seen in FIG. 1. Surface area of bulk powder Cu—Mn spinel on Al₂O₃-9% BaO, Alumino silicate, Al₂O₃-8% CeO₂, Al₂O₃-15% SrO, and Al₂O₃-5% SrO support oxides remains in the range of about 36 to about 45.2 m²/g, however, surface area of bulk powder Cu—Mn spinel on MgAl₂O₄, Al₂O₃-10% La₂O₃, and SiO₂ decreases significantly to about 8 m²/g, about 17 m²/g, and about 8 m²/g, respectively. It may be seen that Al₂O₃-9% BaO, Al₂O₃-8% CeO₂, and Al₂O₃—SrO support oxides are more thermally stable support oxides for Cu—Mn spinel. Additionally, it may be observed that Cu—Mn spinel significantly reduce thermal stability of some support oxide such as SiO₂. These results clearly show that the type of support oxides selected for Cu—Mn spinel compound is very important, since Cu—Mn spinel may reduce thermal stability of support oxides.

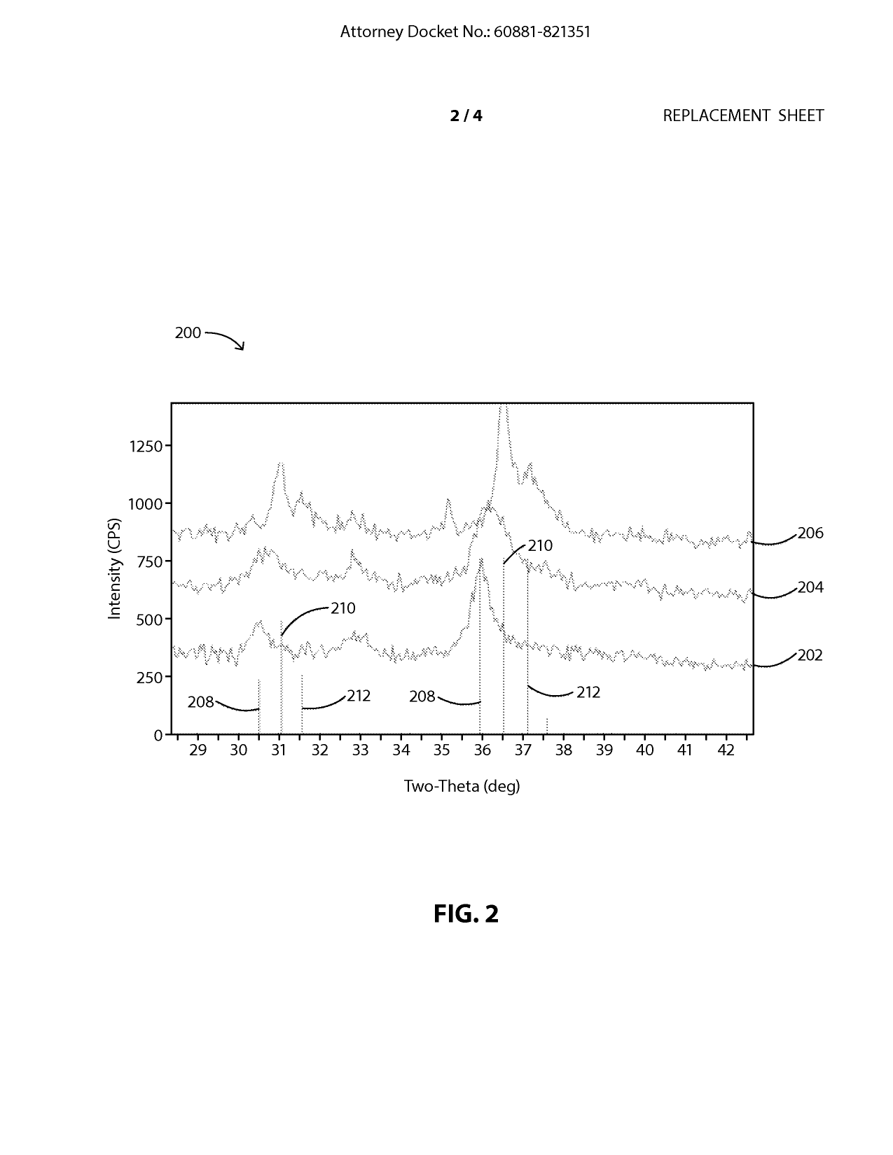

FIG. 2 illustrates XRD analysis 200 for spinel phase formation and spinel phase stability of Cu—Mn on Al₂O₃-5% SrO support oxide, at different firing temperatures, according to an embodiment.

XRD spectrum 202 shows powder Cu—Mn on Al₂O₃-5% SrO catalyst samples calcined at temperature of about 600° C., XRD spectrum 204 illustrates powder Cu—Mn on Al₂O₃-5% SrO catalyst samples calcined at temperature of about 800° C., and XRD spectrum 206 depicts powder Cu—Mn on Al₂O₃-5% SrO catalyst samples calcined at temperature of about 1000° C.

As may be observed in FIG. 2, presence of Cu—Mn spinel at about 600° C. and at about 800° C., as shown by solid lines 208, indicates that the formation of spinel phase on Al₂O₃-5% SrO support oxide occurs at about 600° C., and the spinel phase is stable by increasing the temperature to about 800° C. At about 1000° C., spinel phase does not exist, and CuAl₂O₄ spinel on Al₂O₃-5% SrO support oxide is formed, as shown by solid lines 212. Additionally, MnAl₂O₄ spinel on Al₂O₃-5% SrO support oxide may significantly exist at about 1000° C., but presenting a shoulder at about 800° C., as shown in solid lines 210.

Analysis of influence of variations of support oxides on TWC performance

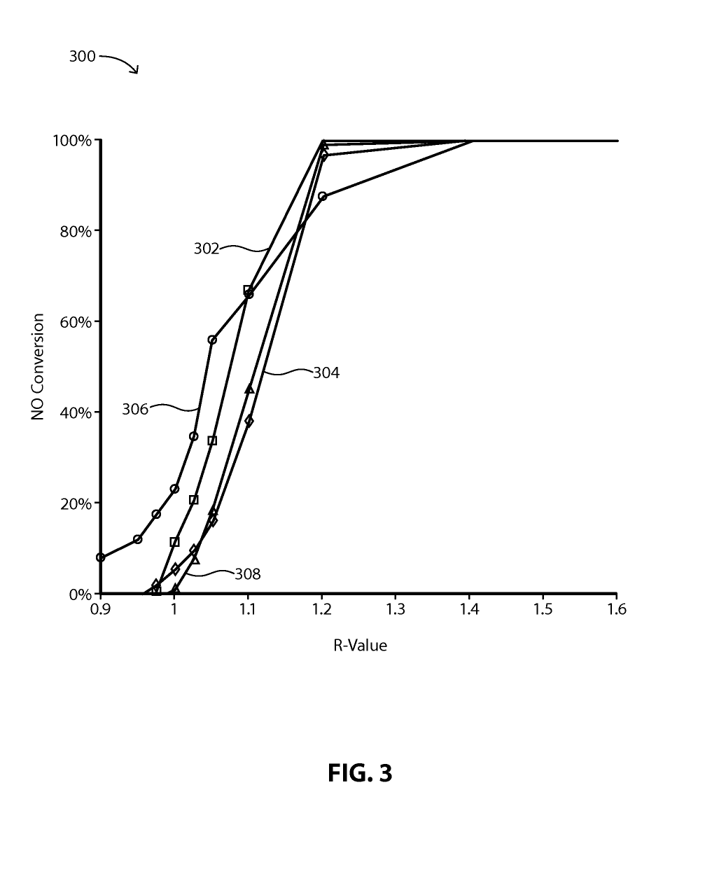

FIG. 3 depicts catalyst performance comparison 300 for powder catalyst samples of Cu—Mn spinel structure on a plurality of selected support oxides and aged at about 800° C., under isothermal steady state sweep condition, at inlet temperature of about 450° C. and SV of about 40,000 h⁻¹, according to an embodiment.

In FIG. 3, conversion curve 302 (solid line with square), conversion curve 304 (solid line with rhombus), conversion curve 306 (solid line with circle), and conversion curve 308 (solid line with triangle) respectively illustrate isothermal steady state sweep test results for NOₓ conversion comparison for Cu—Mn spinel on MgAl₂O₄, Al₂O₃-9% BaO, CeO₂—ZrO₂, and Al₂O₃-15% SrO support oxides.

As may be observed in FIG. 3, the comparison of NOₓ conversion levels, under a range of lean condition to stoichiometric condition and to close stoichiometric condition, catalyst samples of Cu—Mn spinel structure on CeO₂—ZrO₂ support oxide may exhibit higher activity (conversion curve 306) than activity achieved for catalyst samples of Cu—Mn spinel structure prepared with other selected support oxides. Additionally, under rich condition, catalyst samples of Cu—Mn spinel structure on MgAl₂O₄ support oxide may exhibit higher level of activity (conversion curve 302) than that of Cu—Mn spinel structure prepared with other selected support oxides. Moreover, MgAl₂O₄ support oxide after aging at about 800° C. in air shows that NO/CO cross over R-value takes place at the specific R-value of 1.20, where NOₓ and CO conversions are about 99.80%, while CeO₂—ZrO₂ support oxide after aging at about 800° C. in air shows that NO/CO cross over R-value takes place at the specific R-value of 1.40, where NOₓ and CO conversions are about 99.80%. Therefore, overall performance of MgAl₂O₄ support oxide is higher than CeO₂—ZrO₂ support oxide. Moreover, under all regions of R-values from rich condition to stoichiometric condition and to lean condition, catalyst samples of Cu—Mn spinel structure on Al₂O₃-9% BaO and Al₂O₃-15% SrO support oxides show approximately similar NOₓ conversion behavior. Al₂O₃-9% BaO and Al₂O₃-15% SrO support oxides after aging at about 800° C. in air, under isothermal steady state sweep show that NO/CO cross over R-value takes place at the specific R-value of 1.33, where NOₓ and CO conversions are about 98.20%.

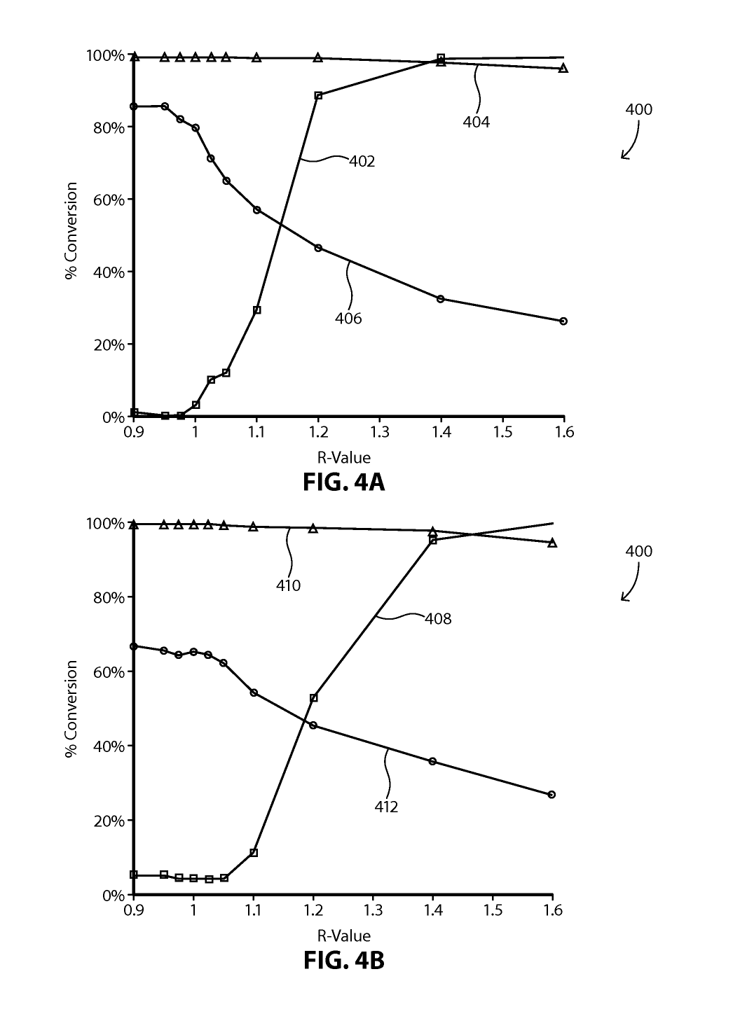

FIG. 4 shows catalyst performance 400 for bulk powder catalyst samples of Cu—Mn spinel structure on Al₂O₃-5% SrO support oxides, under isothermal steady state sweep condition, at inlet temperature of about 450° C. and SV of about 40,000 h⁻¹, according to an embodiment. FIG. 4A illustrates catalyst performance for bulk powder catalyst samples of Cu—Mn spinel structure on Al₂O₃-5% SrO support oxide after aging at about 800° C.; FIG. 4B depicts catalyst performance for bulk powder catalyst samples of Cu—Mn spinel structure on Al₂O₃-5% SrO support oxide after aging at about 1000° C.

In FIG. 4A, conversion curve 402 (solid line with square), conversion curve 404 (solid line with triangle), and conversion curve 406 (solid line with circle) respectively show isothermal steady state sweep test results for NOₓ conversion, CO conversion, and HC conversion for bulk powder catalyst samples of Cu—Mn spinel structure on Al₂O₃-5% SrO support oxide after aging at about 800° C. in air for 4 hours. As may be seen in FIG. 4A, for bulk powder catalyst samples, per Al₂O₃-5% SrO support oxide, NO/CO cross over R-value takes place at the specific R-value of 1.39, where NOₓ and CO conversions are about 99.40%, and HC conversion is about 40%.

In FIG. 4B, conversion curve 408 (solid line with square), conversion curve 410 (solid line with triangle), and conversion curve 412 (solid line with circle) respectively show isothermal steady state sweep test results for NOₓ conversion, CO conversion, and HC conversion for bulk powder catalyst samples of Cu—Mn spinel structure on Al₂O₃-5% SrO support oxide after aging at about 1000° C. in air for 4 hours. As may be observed in FIG. 4B, for bulk powder catalyst samples, NO/CO cross over R-value takes place at the specific R-value of 1.46, where NOₓ and CO conversions are about 96.95%, and HC conversion is about 34.50%.

Additionally, it may be seen that bulk powder catalyst samples of spinel on Al₂O₃-5% SrO support oxide show a good activity at about 1000° C., indicating very good thermal stability of ZPGM catalyst.

The type of support oxides has significant effect on thermal stability of Cu—Mn spinel in ZPGM catalyst. The thermal stability of support oxides before and after deposition of Cu—Mn has been shown by measuring surface area after aging at about 1000° C. After deposition of Cu—Mn spinel powder on support oxides and aging at about 1000° C., surface area decreases in comparison with surface area of bare support oxides at the same aging temperature. The degree of surface area loss is different and depends on the type of support oxides. Al₂O₃-9% BaO, Al₂O₃—SrO, and Al₂O₃-8% CeO₂ are thermally stable support oxides for Cu—Mn spinel. However, some support oxides such as SiO₂ and MgAl₂O₄ do not show thermal stability, although indicating high activity under fresh condition. As may be observed, Cu—Mn spinel on Al₂O₃-5% SrO support oxide is formed at about 600° C., and the spinel phase is stable by increasing the temperature to about 800° C. CuAl₂O₄ and MnAl₂O₄ spinels on Al₂O₃-5% SrO support oxide may significantly exist at about 1000° C. The high activity of Cu—Mn on Al₂O₃-5% SrO after aging at about 800° C. may be related to presence of Cu—Mn spinel at this temperature, and stability of activity at high temperature as about 1000° C. can be related to presence of stable CuAl₂O₄ and MnAl₂O₄ spinels at this temperature.

Bulk powder catalyst samples of Cu—Mn spinel structure on selected support oxides may improve catalytic TWC performance when employed in ZPGM catalysts for a plurality of TWC applications, thus leading to a more effective utilization of ZPGM catalyst materials in TWC converters.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A zero platinum group metal (ZPGM) material composition comprising a copper-manganese (Cu—Mn) spinel structure on a plurality of support oxides.

2. The ZPGM material composition of claim 1, wherein the Cu—Mn structure is of the formula CuxMn3-xO4, where X is about 0.02 to about 1.5.

3. The ZPGM material composition of claim 2, wherein the formula is CuMn2O4.

4. The ZPGM material composition of claim 1, wherein the support structure is selected from the group consisting of MgAl2O4, Al2O3-BaO, Al2O3-La2O3, ZrO2-CeO2-Nd2O3-Y2O3, CeO2-ZrO2, CeO2, SiO2, ZrO2-Y2O3-SiO2, Al2O3-CeO2, Al2O3-SrO, TiO2-10% ZrO2, TiO2-10% Nb2O5, SnO2-TiO2, ZrO2-SnO2- TiO2, BaZrO3, BaTiO3, BaCeO3, ZrO2-P6O11, ZrO2-Y2O3, ZrO2-Nb2O5, and combinations thereof.

5. The ZPGM material composition of claim 4, wherein the Al2O3-SrO is Al2O3-5% SrO or Al2O3-15% SrO.

6. The ZPGM material composition of claim 1, wherein the support structure is Al2O3-5% SrO.

7. The ZPGM material composition of claim 4, wherein the Al2O3-BaO is Al2O3-9% BaO.

8. The ZPGM material composition of claim 4, wherein the Al2O3-CeO2 is Al2O3-8% CeO2.

9. The ZPGM material composition of claim 1, wherein the support structure is an alumino silicate.

10. The ZPGM material composition of claim 1, wherein the composition is a bulk powder.

11. The ZPGM material composition of claim 10, wherein the bulk powder is a fine grain bulk powder.

12. The ZPGM material composition of claim 1, wherein the Cu—Mn spinel structure is calcined material of Cu—Mn binary spinel structure.

13. The ZPGM material composition of claim 1, wherein the support oxides have a surface area of about 80 to about 200 m2/g after aging.

14. A zero platinum group metal (ZPGM) material composition comprising a CuMn2O4 spinel structure on a plurality of Al2O3-SrO support oxides.

15. A ZPMG catalyst comprising ZPGM material composition of claim 1.

16. The ZPMG catalyst of claim 15, wherein the catalyst is a three-way catalyst.

17. A method of producing a zero platinum group metal (ZPGM) material composition comprising ageing the material at a temperature of about 1000° C., wherein the ZPGM material composition comprises a copper-manganese (Cu—Mn) spinel structure on a plurality of support oxides.

18. The method of claim 17, wherein the ageing is about 5 hours.

19. The method of claim 17, wherein the support structure is selected from the group consisting of MgAl2O4, Al2O3-BaO, Al2O3-La2O3, ZrO2-CeO2-Nd2O3-Y2O3, CeO2-ZrO2, CeO2, SiO2, ZrO2-Y2O3- SiO2, Al2O3-CeO2, Al2O3-SrO, TiO2-10% ZrO2, TiO2-10% Nb2O5, SnO2-TiO2, ZrO2-SnO2-TiO2, BaZrO3, BaTiO3, BaCeO3, ZrO2-P6O11, ZrO2-Y2O3, ZrO2-Nb2O5, and combinations thereof.

20. The method of claim 17, wherein the support oxides have a surface area of about 80 to about 200 m2/g after aging.
